(19) United States
(12) Patent Application Publication
(10) Pub. No.: US 2012/0173564 A1
(43) Pub. Date: Jul. 5, 2012

(54) SYSTEM AND METHOD FOR PROVIDING A COMPARE CHANNEL TOOL

(75) Inventors: Veluvarthi Narasinga Rao, Hyderabad (IN); Mohammad Raffee Vadla, Hyderabad, AP (IN); Srikanth Maharna, Hitech City (IN); Kevin R. Garrison, Wesley Chapel, FL (US); Ovid Lane Hunt, Salsbury Mills, NY (US)

(73) Assignee: VERIZON PATENT AND LICENSING, INC., Basking Ridge, NJ (US)

(21) Appl. No.: 12/981,586

(22) Filed: Dec. 30, 2010

(51) Int. Cl. G06F 17/30

(52) U.S. Cl. 707/769; 707/E17.014

(57) ABSTRACT

A system and method for providing a compare channel tool is disclosed. The system may comprise an input module configured to receive at least one instruction for a comparison action based on a user selection and to receive two or more items for comparison processing based on user input. A processor module configured to process the two or more items for comparison processing based on the instructions may also be provided. An output module configured to output the comparison results of the two or more items at a user display may also be provided.

### BACKGROUND INFORMATION

A number of systems management technologies have been developed to unify and facilitate management of distributed computing environments. Some key features of systems management technologies include remote management of applications, management of several instances of an application, remote application interfacing across difference platforms, and application management decoupling. In addition, these systems management technologies are generally capable of deploying and maintaining a wide variety of information, called packages, whether in individual files or entire software suites. These packages may be deployed or distributed to various clients and system components in one or more channels. However, current system management technologies do not provide a comprehensive and efficient way to compare to two or more channels.

### BRIEF DESCRIPTION OF THE DRAWINGS

In order to facilitate a fuller understanding of the exemplary embodiments, reference is now made to the appended drawings. These drawings should not be construed as limiting, but are intended to be exemplary only.

FIG. 1 depicts a block diagram of a system architecture for providing a compare channel tool, according to an exemplary embodiment.

FIG. 2 depicts a hardware module component of a system for providing a compare channel tool, according to an exemplary embodiment.

FIG. 3A depicts an illustrative screen for providing a compare channel tool, according to an exemplary embodiment.

FIG. 3B depicts an illustrative screen for providing a compare channel tool with a list of comparison options, according to an exemplary embodiment.

FIG. 4A depicts an illustrative screen for providing a time stamp comparison using a compare channel tool, according to an exemplary embodiment.

FIG. 4B depicts an illustrative flow for providing a time stamp comparison using a compare channel tool, according to an exemplary embodiment.

FIG. 5A depicts an illustrative screen for providing a time stamp comparison using a compare channel tool, according to another exemplary embodiment.

FIG. 5B depicts an illustrative flow for providing a time stamp comparison using a compare channel tool, according to another exemplary embodiment.

FIG. 5C depicts an illustrative output screen of a time stamp comparison using a compare channel tool, according to an exemplary embodiment.

FIG. 6A depicts an illustrative screen for providing a standard comparison using a compare channel tool, according to an exemplary embodiment.

FIG. 6B depicts an illustrative flow for providing a standard comparison using a compare channel tool, according to an exemplary embodiment.

FIG. 6C depicts an illustrative output screen of a standard comparison using a compare channel tool, according to an exemplary embodiment.

FIG. 7A depicts an illustrative screen for providing a standard comparison using a compare channel tool, according to another exemplary embodiment.

FIG. 7B depicts an illustrative flow for providing a standard comparison using a compare channel tool, according to another exemplary embodiment.

FIG. 8A depicts an illustrative screen for providing a policies comparison using a compare channel tool, according to an exemplary embodiment.

FIG. 8B depicts an illustrative flow for providing a policies comparison using a compare channel tool, according to an exemplary embodiment.

FIG. 8C depicts an illustrative output screen of a policies comparison using a compare channel tool, according to an exemplary embodiment.

FIG. 9A depicts an illustrative screen for providing a verification comparison using a compare channel tool, according to an exemplary embodiment.

FIG. 9B depicts an illustrative flow for providing a verification comparison using a compare channel tool, according to an exemplary embodiment.

FIG. 10A depicts an illustrative screen for providing a verification comparison using a compare channel tool, according to another exemplary embodiment.

FIG. 10B depicts an illustrative flow for providing a verification comparison using a compare channel tool, according to another exemplary embodiment.

FIG. 10C depicts an illustrative output screen of a verification comparison using a compare channel tool, according to an exemplary embodiment.

FIG. 11A depicts an illustrative screen for providing a parameters comparison using a compare channel tool, according to an exemplary embodiment.

FIG. 11B depicts an illustrative flow for providing a parameters comparison using a compare channel tool, according to an exemplary embodiment.

FIG. 12 depicts an illustrative screen for providing more comparison options using a compare channel tool, according to an exemplary embodiment.

FIG. 13 depicts an illustrative flowchart of a method for providing a compare channel tool, according to an exemplary embodiment.

FIG. 14 depicts an illustrative flowchart of a method for using a compare channel tool, according to another exemplary embodiment.

### DETAILED DESCRIPTION OF EMBODIMENTS

Reference will now be made in detail to exemplary embodiments, examples of which are illustrated in the accompanying drawings. It should be appreciated that the same reference numbers will be used throughout the drawings to refer to the same or like parts. It should be appreciated that the following detailed description are exemplary and explanatory only and are not restrictive.

Exemplary embodiments may provide a system and method for providing a compare channel tool. That is, exemplary embodiments may, among other things, expand and optimize systems management within distributed computing environments by comprehensively and effectively providing a compare channel tool to facilitate comparisons of two or more distributed packages.

As discussed above, systems management technologies are useful for unifying and facilitating management of distributed computing environments. These systems management technologies are generally capable of deploying and maintaining a wide variety of information, called packages, whether in individual files or entire software suites. These packages may be deployed or distributed to various clients and system components in one or more channels. However, comparisons between two or more distributed packages may be typically performed manually or in other inefficient and cumbersome ways using current system management technologies. Using a compare channel tool according to various embodiments, a comprehensive and efficient way to compare to two or more channels may be provided.

For example, in the event a package is distributed as “Channel A” to one or more clients, the package may include a variety of settings, registry keys, etc. Then, assuming an updated version of the package is ready to be distributed, it may be distributed as “Channel B.” However, it may be the case that Channel B does not include some of the settings and registry keys found in Channel A. Distributing Channel B, as is, would effectively overwrite Channel A and cause some of those settings and registry keys, originally distributed in Channel A, to be deleted. Distribution of Channel B may therefore cause the file or software suite, derived from the package, to be inoperable or result in other various complications.

According to various embodiments, a compare channel tool may be used to compare the new channel (e.g., Channel B) with the previous channel (e.g., Channel A) so that a comparison output, such a list or report, may be generated and presented. In this way, everything that was new or updated in the new channel and everything that no longer exists in the new channel may be presented. Not only would this comparison output be useful in troubleshooting when new or updated channels are distributed, but the compare channel tool may be useful for packaging contents of new or updated channels even before package distribution. A compare channel too may therefore eliminate, mitigate, or preempt complications or discrepancies associated with package distribution.

It should be appreciated that the term, “channel,” as used herein, may refer to any package for distribution for comparison at the compare channel tool. As discussed above, a package may include a file or a plurality of files, such as an application suite, as well as all associated settings, registry keys, metadata, etc. Although embodiments of the present disclosure are primarily discussed with respect to comparison of two or more channels, it should be appreciated that comparisons of other types of data may also be provided using the channel compare tool.

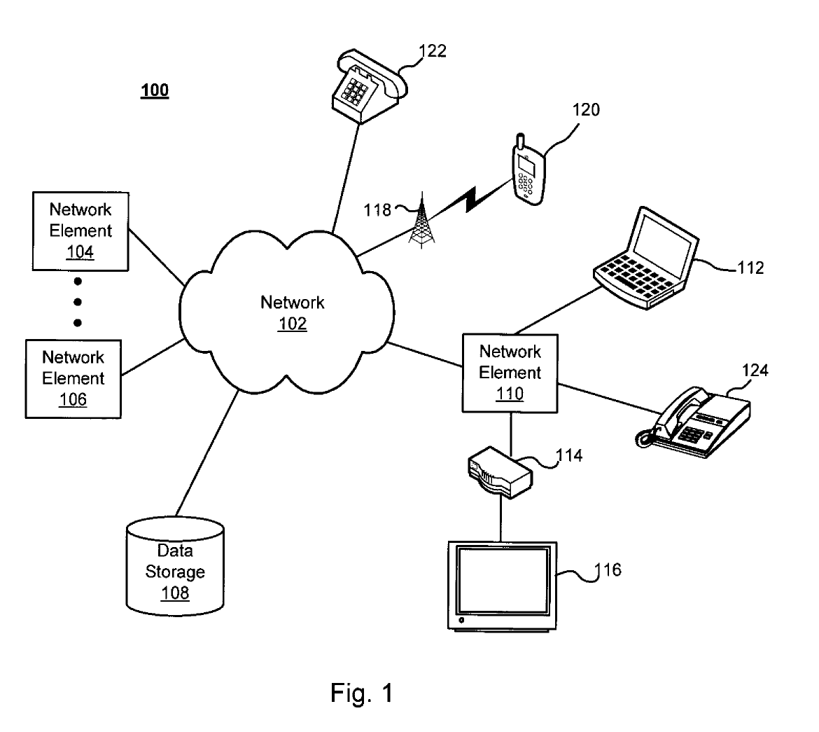

FIG. 1 depicts a block diagram of a system architecture for providing a compare channel tool, according to an exemplary embodiment. As illustrated, network 102 may be communicatively coupled with one or more devices including network element 104, network element 106, data storage 108, and network element 110. Other devices may be communicatively coupled with network 102 via one or more intermediary devices, such as transceiver 118, network element 110, or a wireline phone 122. Wireless device 120 may be communicatively coupled with network 102 via transceiver 118. Network client 112 and set-top box 114 may be communicatively coupled with network 102 via network element 110. Wireless control 110 may be communicatively coupled with set-top box 114 via infrared, Bluetooth communication, or other wireless technologies. A video display (e.g., television set 116) may be communicatively coupled to set-top box 114. It should also be appreciated that other various components may also be communicatively coupled with the network element 110, such as a Voice over Internet Protocol (“VoIP”) phone 124.

Network 102 may be a wireless network, a wired network or any combination of wireless network and wired network. For example, network 102 may include one or more of a fiber optics network, a passive optical network, a cable network, an Internet network, a satellite network (e.g., operating in Band C, Band Ku or Band Ka), a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.1, 802.11n and 802.11g or any other wired or wireless network for transmitting or receiving a data signal. In addition, network 102 may include, without limitation, telephone line, fiber optics, IEEE Ethernet 802.3, a wide area network (“WAN”), a local area network (“LAN”), or a global network such as the Internet. Also, network 102 may support, an Internet network, a wireless communication network, a cellular network, or the like, or any combination thereof. Network 102 may further include one, or any number of the exemplary types of networks mentioned above operating as a stand-alone network or in cooperation with each other. Network 102 may utilize one or more protocols of one or more network elements to which it is communicatively coupled. Network 102 may translate to or from other protocols to one or more protocols of network devices. Although network 102 is depicted as one network, it should be appreciated that according to one or more embodiments, network 102 may comprise a plurality of interconnected networks, such as, for example, a service provider network, the Internet, a broadcaster's network, a cable television network, corporate networks, or home networks.

Network elements 104, 106, 110, and data storage 108 may transmit and receive data to and from network 102 representing broadcast content, user request content, mobile communications data, or other data. The data may be transmitted and received utilizing a standard telecommunications protocol or a standard networking protocol. For example, one embodiment may utilize Session Initiation Protocol (“SIP”). In other embodiments, the data may be transmitted or received utilizing other Voice Over IP (“VOIP”) or messaging protocols. For example, data may also be transmitted or received using Wireless Application Protocol (“WAP”), Multimedia Messaging Service (“MMS”), Enhanced Messaging Service (“EMS”), Short Message Service (“SMS”), Global System for Mobile Communications (“GSM”) based systems, Code Division Multiple Access (“CDMA”) based systems, Transmission Control Protocol/Internet (“TCP/IP”) Protocols, or other protocols and systems suitable for transmitting and receiving data. Data may be transmitted and received wirelessly or may utilize cabled network or telecom connections such as an Ethernet RJ45/Category 5 Ethernet connection, a fiber connection, a traditional phone wireline connection, a cable connection or other wired network connection. Network 102 may use standard wireless protocols including IEEE 802.11a, 802.11b and 802.11g. Network 102 may also use protocols for a wired connection, such as an IEEE Ethernet 802.3.

Transceiver 118 may be a repeater, a microwave antenna, a cellular tower, or another network access device capable of providing connectivity between to different network mediums. Transceiver 118 may be capable of sending or receiving signals via a mobile network, a paging network, a cellular network, a satellite network or a radio network. Transceiver 118 may provide connectivity to one or more wired networks and may be capable of receiving signals on one medium such as a wired network and transmitting the received signals on a second medium, such as a wireless network.

Wireless device 120 may be a mobile communications device, wireline phone, a cellular phone, a mobile phone, a satellite phone, a personal digital assistant (“PDA”), a computer, a handheld MP3 player, a handheld multimedia device, a personal media player, a gaming device, or other devices capable of communicating with network 102 via transceiver 118.

Network elements, transceiver 118, data storage 108, and set-top box 114 may include one or more processors for recording, transmitting, receiving, or storing data. Although network elements, transceiver 118 and data storage 108 are depicted as individual elements, it should be appreciated that the contents of one or more of a network element, transceiver 118, and data storage 108 may be combined into fewer or greater numbers of devices and may be connected to additional devices not depicted in FIG. 1. Furthermore, the one or more devices may be local, remote, or a combination thereof a first network elements, transceiver 118, and data storage 108.

Data storage 108 may be network accessible storage and may be local, remote, or a combination thereof to network elements 104, 106, and 110. Data storage 108 may utilize a redundant array of inexpensive disks (“RAID”), tape, disk, a storage area network (“SAN”), an internet small computer systems interface (“iSCSI”) SAN, a Fibre Channel SAN, a common Internet File System (“CIFS”), network attached storage (“NAS”), a network file system (“NFS”), or other computer accessible storage. In one or more embodiments, Data storage 108 may be a database, such as an Oracle database, a Microsoft SQL Server database, a DB2 database, a MySQL database, a Sybase database, an object oriented database, a hierarchical database, or other database. Data storage 108 may utilize flat file structures for storage of data.

Network elements 104, 106, and 110 may be one or more servers (or server-like devices), such as a Session Initiation Protocol (“SIP”) server. Network elements 104, 106, and 110 may include one or more processors (not shown) for recording, transmitting, receiving, or storing data. According to one or more embodiments, network elements 104, 106, and 110 may be servers providing media content to one or more users. In other embodiments, network elements 104, 106, and 110 may be servers that provide network connection between two or more wireless devices 118. Network elements 104, 106, and 110 may also be servers of a service provider, the Internet, a broadcaster, a cable television network, or another media provider.

Network element 110 may be a residential gateway, such as a router, an optical network terminal or another piece of Customer Premises Equipment (“CPE”) providing access to one or more pieces of equipment. For example, network element 110 may provide audio/video programming content feeds to a set-top box, such as set-top box 116. Network element 110 may also provide network connectivity for other clients, such as a Voice Over IP (“VOIP”) phone (not shown) and a network client, e.g., network client 112.

Network client 112 may be a desktop computer, a laptop computer, a server, a personal digital assistant, or other computer capable of sending or receiving network signals (e.g., CPE, a television, radio, phone, appliance, etc.). Network client 112 may use a wired or wireless connection. It should also be appreciated that the network client 112 may be a portable electronic device capable of being transported. For example, these may include a digital picture frame, an electronic reader device, or other portable device. Such a device may transmit or receive signals and store information in transit, and in the event it is transported out of the unit, the portable electronic device may still operate using the data (e.g., digital image, electronic book, etc.) it stored. Although depicted as connected via a residential gateway in FIG. 1, it should be appreciated that the network client 112 may connect directly to network 102 or via other network connectivity devices as well. According to one or more embodiments, network client 112 using a wireless connection may authenticate with a network using Wired Equivalent Privacy (“WEP”), Wi-Fi Protected Access (“WPA”), or other wireless network security standards.

System 100 may be used for mobile telecommunications between two or more components of the system 100, e.g., two or more wireless devices, wireless device with network client, set top box with wireless device, landline phone, VoIP, etc. System 100 may also be used for transmitting or receiving multimedia content. The various components of system 100 as shown in FIG. 1 may be further duplicated, combined or integrated to support various applications and platforms. Additional elements may also be implemented in the systems described above to support various applications.

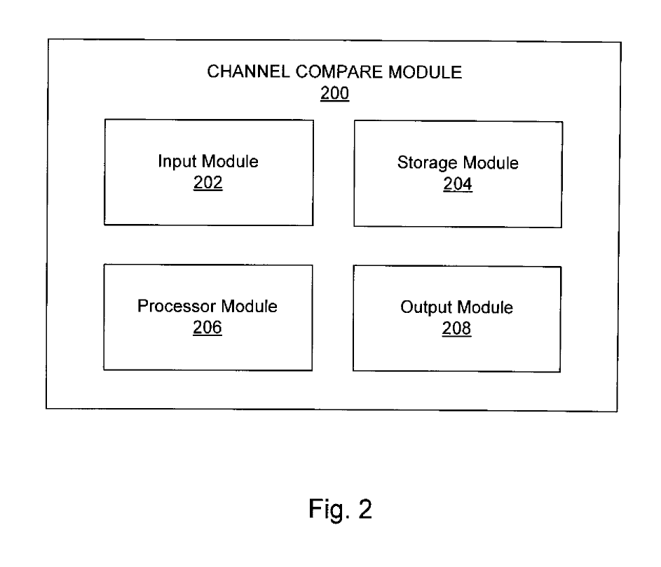

FIG. 2 depicts a hardware module component of a system for providing a compare channel tool, according to an exemplary embodiment. Referring to FIG. 2, there is shown a channel compare module 200 for providing a compare channel tool. As illustrated, the channel compare module 200 may contain one or more components, such as an input module 202, a storage module 204, a processor module 206, and an output module 208. Although the channel compare module 200 is depicted as a single module, the channel compare module 200 may be incorporated as a single component or may be distributed across a plurality of physical components, such as one or more centralized servers, pieces of customer premises equipment, or end user devices. In some embodiments, the channel compare module 200 may be utilized in a virtual environment or as software.

The description below describes network elements, computers, and components of a system of and method for providing a compare channel tool that may include one or more modules. As used herein, the term “module” may be understood to refer to non-transitory executable software, firmware, hardware, and various combinations thereof. Modules however are not to be interpreted as software which is not implemented on hardware, firmware, or recorded on a processor readable recordable storage medium (i.e., modules are not software per se). It is noted that the modules are exemplary. The modules may be combined, integrated, separated, and duplicated to support various applications. Also, a function described herein as being performed at a particular module may be performed at one or more other modules and by one or more other devices instead of or in addition to the function performed at the particular module. Further, the modules may be implemented across multiple devices and other components local or remote to one another. Additionally, the modules may be moved from one device and added to another device, and may be included in both devices.

Input module 202 may receive one or more inputs. These may include input files designated for comparison processing. Storage module 204 may manage or access the one or more inputs using electronic storage, including databases or other organized electronic storage. Storage module 204 may provide one or more interfaces for the input module 202, processor module 206, or output module 208. Storage module 204 may store any data associated with the input module 202, processor module 206, and output module 208. Storage module 204 may be or may be communicatively coupled to one or more physical media, such as, but not limited to, a compact disc (CD), a digital versatile disc (DVD), a floppy disk, a hard drive, read only memory (ROM), random access memory (RAM), as well as other physical media capable of storing software, data, other storage information, or combinations thereof.

Processor module 206 may process the data. For example, processor module 206 may process and compare various input files from the input module 202 or the storage module 204. Output module 208 may output the processed data. For example, output module 208 may output the processed comparison data in one or more reports or other readable files (e.g., a text file).

In some embodiments, the channel comparison module 200 may provide comparison of data. The data comparisons may include standard comparisons, time/date comparisons, policies comparisons, verification comparisons, parameters comparisons, and other data comparisons. Details of these exemplary data comparisons will be explained in further detail below.

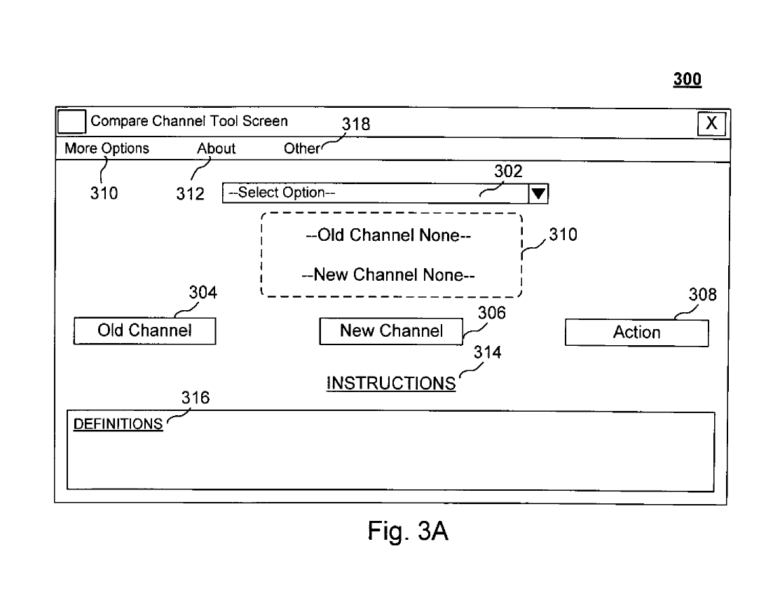

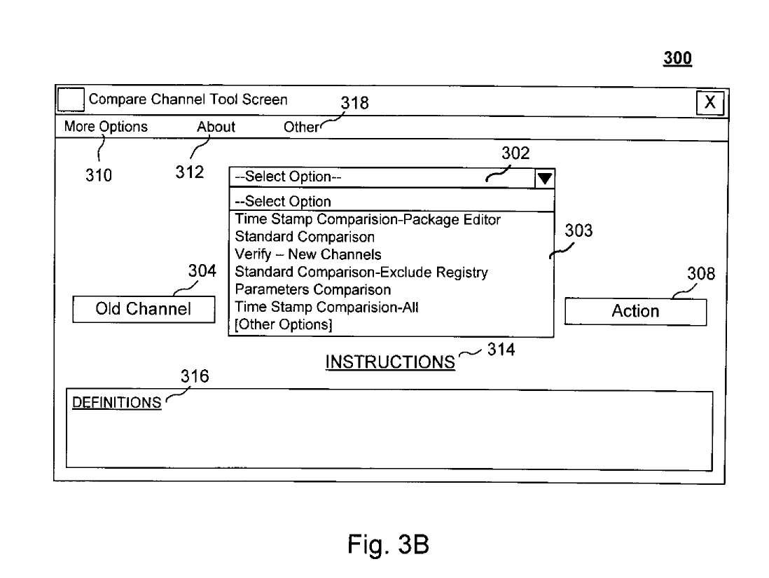

FIG. 3A depicts an illustrative screen for providing a compare channel tool 300, according to an exemplary embodiment. In this example, the compare channel tool screen 300 may include several selectable options. These may include a pull-down menu 302, a button for selecting an “Old Channel” 304, a button for selecting a “New Channel” 306, and a button selecting an “Action” 308 (e.g., to perform the action of comparing the differences between the old channel and the new channel). There may also be a comparison area 310 on the screen to show what is being compared. Specifically identifying the target channels may help to ensure that the proper channels are being compared.

Other selectable options may include hyperlinks for additional information or actions. These may include a “More Options” hyperlink 310 for presenting more channel comparison options, an “About” hyperlink 312 for presenting information of about the compare channel tool, an “Instructions” hyperlink 314 for presenting information regarding on how to use the compare channel tool, a “Definitions” hyperlink or display area 316 for presenting definitions on the type of actions that will be performed with a particular action or comparison, and an “Other” hyperlink 318 for presenting other related information for the user. Details and functions this compare channel tool screen 300 will become apparent as various embodiments are explained in further detail below.

FIG. 3B depicts an illustrative screen for providing a compare channel tool 300 with a list of comparison options 303, according to an exemplary embodiment. Referring to the compare channel tool screen 300, then the pull-down menu 302 is opened, a list of comparison options 303 may be presented, showing a variety of options for comparison processing, such as Time Stamp, Standard, Verify—New Channels, Standard—Exclude Registry, Parameters, Time Stamp—All, and a variety of other comparison options.

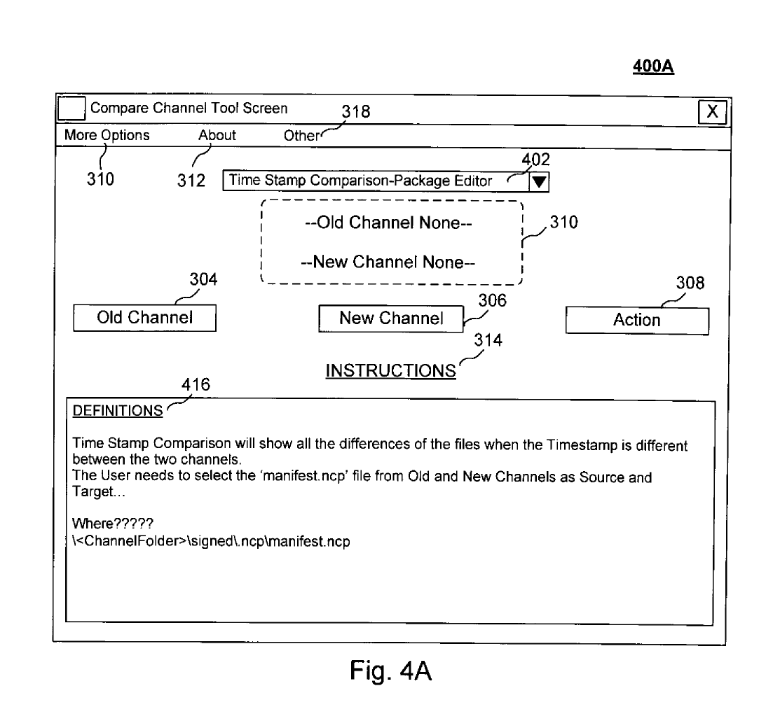

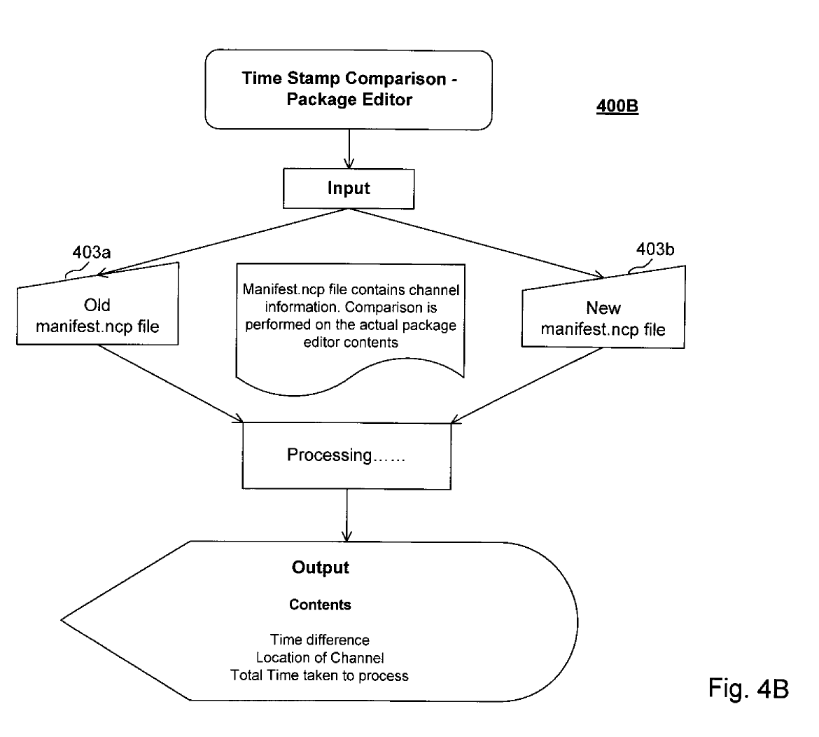

FIG. 4A depicts an illustrative screen for providing a time stamp comparison using a compare channel tool 400A, according to an exemplary embodiment. In this example, the compare channel tool screen 400A is similar to the compare channel tool screen 300 of FIG. 3. In this embodiment, a Time Stamp Comparison option 402 may be selected from the pull-down menu 402. The Time Stamp Comparison may be a Time Stamp Comparison (Package Editor) selection, which will be discussed in further detail below. It should be appreciated that the Definitions hyperlink or display area 416 may reflect the option selected and provide definitions of the type of actions that may be performed with that particular action or comparison, etc. In this example, the Definitions hyperlink or display area 416 may present information related to the Time Stamp Comparison option or other associated actions or results.

FIG. 4B depicts an illustrative flow for providing a time stamp comparison using a compare channel tool 400B, according to an exemplary embodiment. Details of the flow 400B may include description of the compare channel module 200 and various components of FIG. 2. Referring to flow 400B for providing a time stamp comparison, the input module 202 may receive an old file 403a and a new file 403b. The old file 403a and new file 403b may be *.ncp files, such as “manifest.ncp” files, which may be a compatible file format for performing comparisons described herein. In this example, the manifest.ncp file may comprise channel information and the time stamp comparison may be performed on the actual package editor contents at the processor module 206. Although embodiments are described using a *.ncp file, other various file types useful for comparisons may also be provided. Furthermore, the storage module 204 may store the manifest.ncp files or other associated files for any duration or predetermined time. In the flow 400B, the output of the output module 208 may be a file comprising content or comparison information, such as a text file or other similar output file (e.g., xml, csv, xls, html, etc.). The comparison information outputted may include time difference of the files, location of channels, time taken to process the comparison, etc.

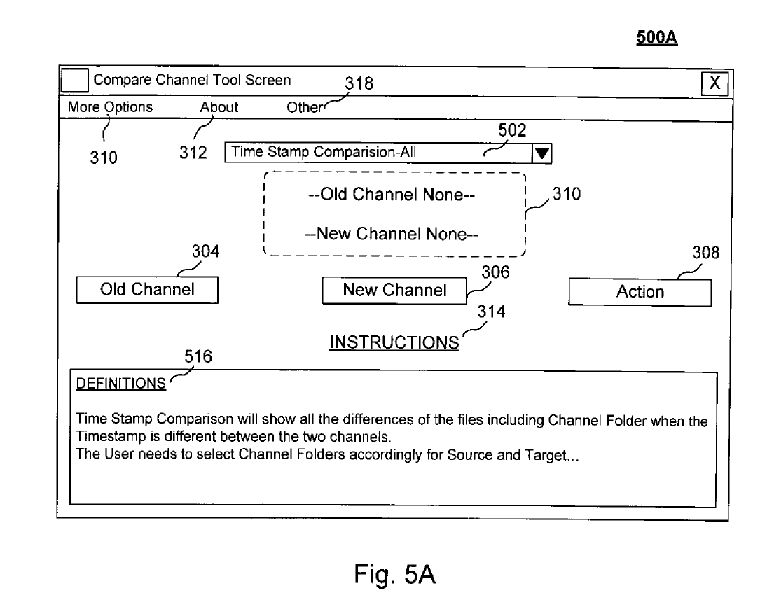

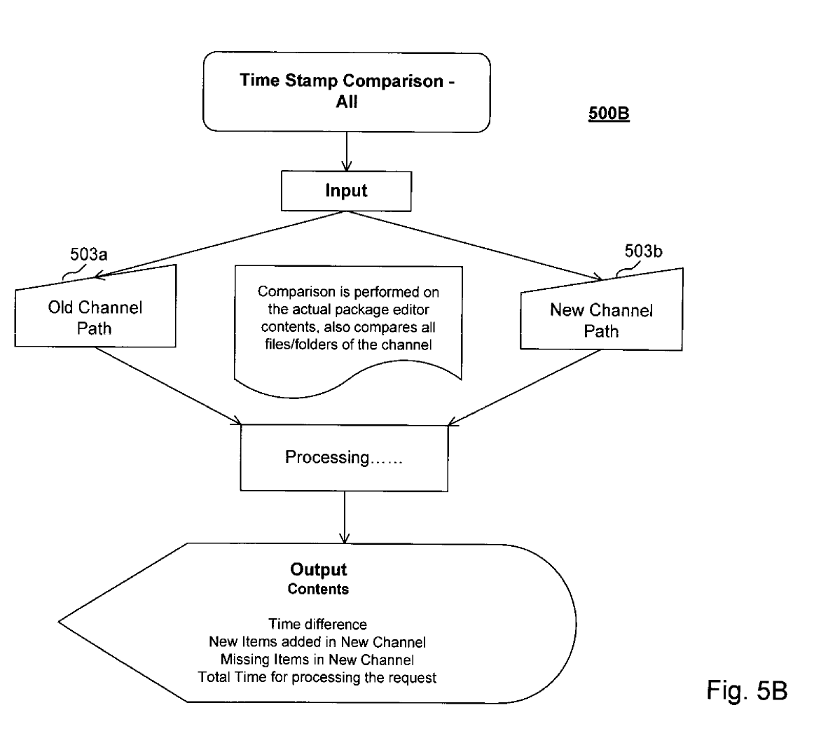

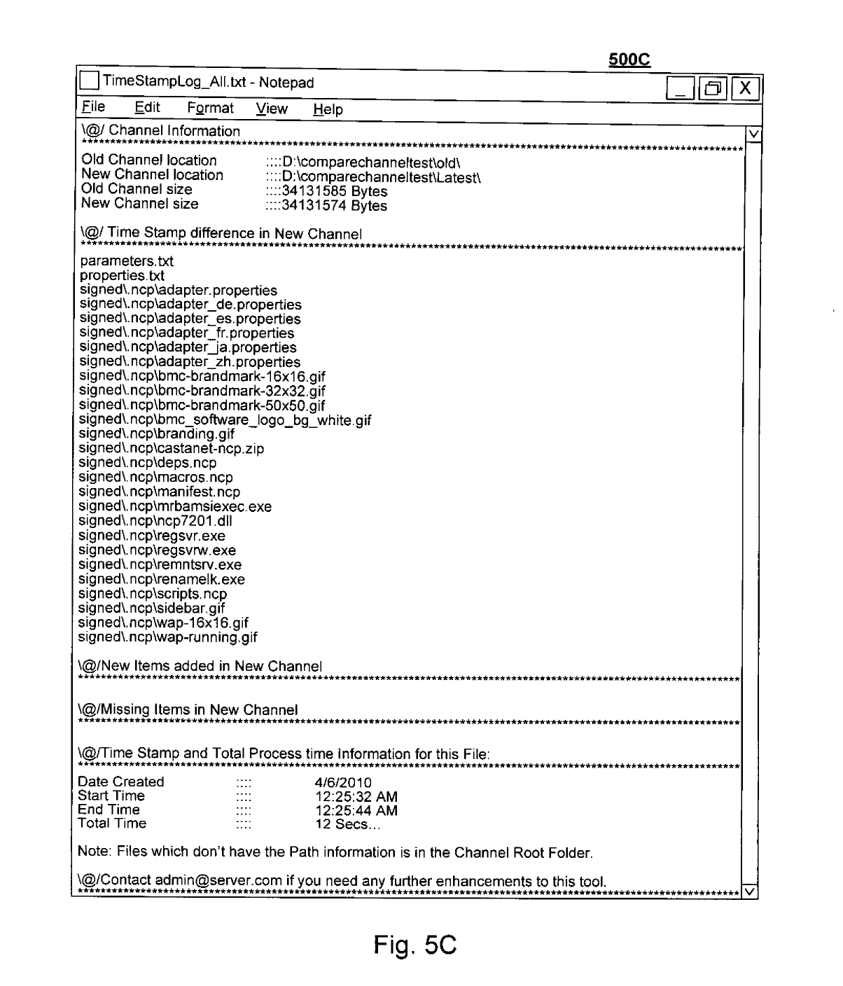

FIG. 5A depicts an illustrative screen for providing a time stamp comparison using a compare channel tool 500A, according to another exemplary embodiment. In this example, the compare channel tool screen 500A is similar to the compare channel tool screen 300 of FIG. 3. In this embodiment, a Time Stamp Comparison option 502 may be selected from the pull-down menu 502. The Time Stamp Comparison may by a Time Stamp Comparison (All) selection, which will be discussed in further detail below. It should be appreciated that the Definitions hyperlink or display area 416 may reflect the option selected and provide definitions of the type of actions that may be performed with that particular action or comparison, etc. In this example, the Definitions hyperlink or display area 516 may present information related to the Time Stamp Comparison (All) option and/or other associated actions or results.

FIG. 5B depicts an illustrative flow for providing a time stamp comparison using a compare channel tool 500B, according to another exemplary embodiment. Details of the flow 500B may include description of the compare channel module 200 and its various components of FIG. 2. Referring to flow 500B for providing a time stamp comparison, the input module 202 may receive an old channel path 503a and a new channel path 503b. The old channel path 503a and new channel path 503b may include files or folders of the channel. In this example, not only may the actual package editor and its content be compared, but the processor module 206 may compare all the file and folders of the channel as well. Furthermore, the storage module 204 may store the files and/or folders for any duration or predetermined time. In the flow 500B, the output of the output module 208 may be a file comprising content or comparison information, such as a text file or other similar output file (e.g., xml, csv, xls, html, etc.). The comparison information outputted may include time difference, new items added in the new channel, missing items in the new channel, total time taken to process the comparison, etc.

FIG. 5C depicts an illustrative output screen of a time stamp comparison using a compare channel tool 500C, according to an exemplary embodiment. In the screen 500C, a “TimeStampLog_All.txt” output file may have several headings under which the comparison information may be displayed. For example, under a “\@/ Channel Information” header, comparison information related to the old and new channel location and sizes may be presented. Under a “\@/ Time Stamp difference in New Channel” header, comparison information related to what files are new or different from the old channel may be listed. Comparison information related to new items in the new channel may be displayed under “\@/ New Items added in New Channel,” comparison information related to missing items in the new channel may be displayed under “\@/ Missing Items in New Channel,” and comparison information related to date of creation, start time, end time, and total time of the comparison may be displayed under the “\@/Time Stamp and Total Process time Information for this File.” Although depicted using these specific headers and comparison information, other headers and comparison information may also be provided.

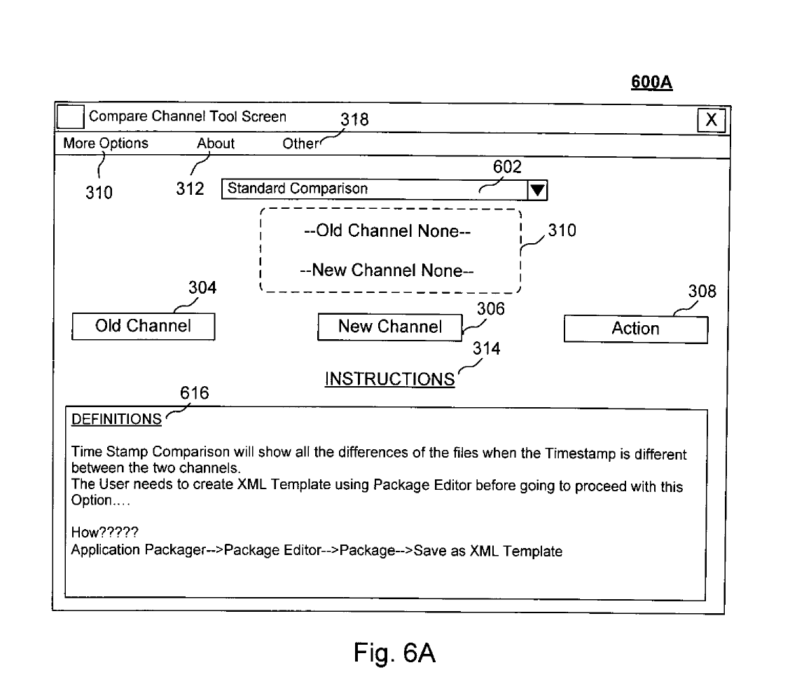

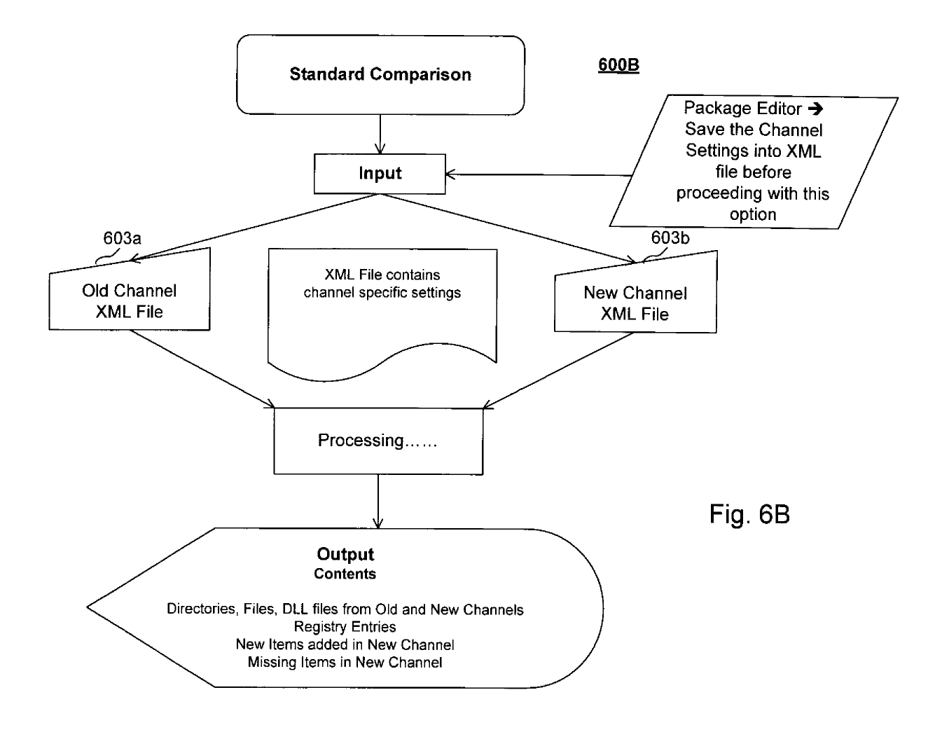

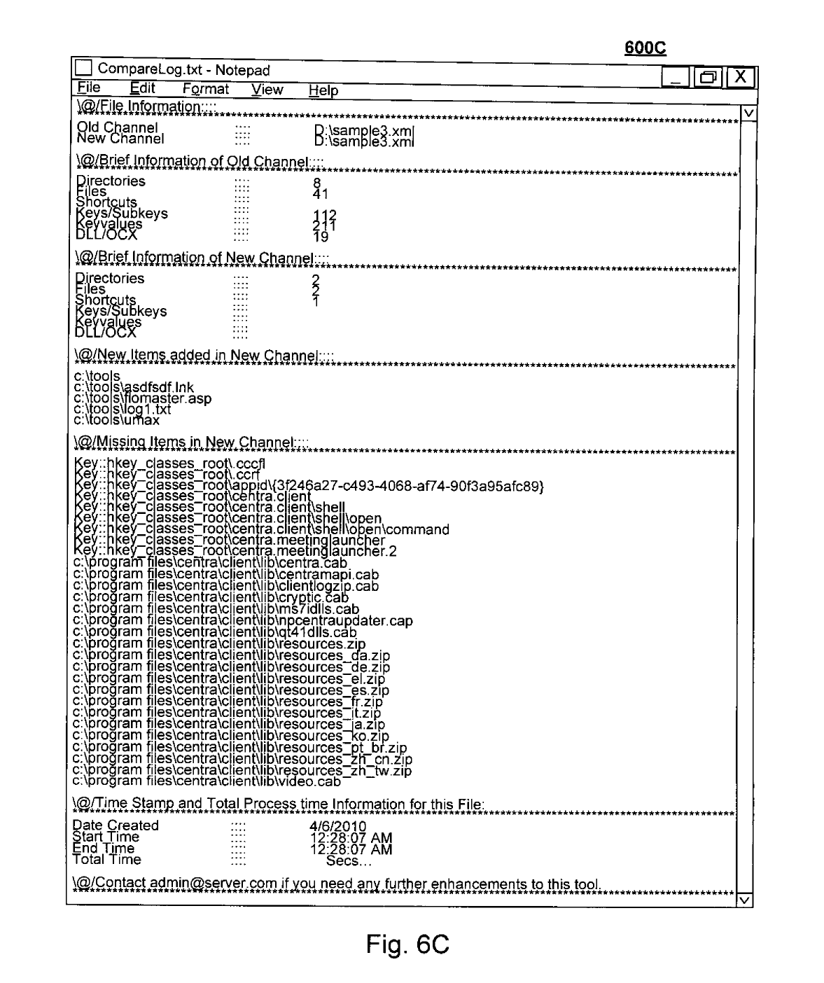

FIG. 6A depicts an illustrative screen for providing a standard comparison using a compare channel tool 600A, according to an exemplary embodiment. In this example, the compare channel tool screen 600A is similar to the compare channel tool screen 300 of FIG. 3. In this embodiment, a Standard Comparison option 602 may be selected from the pull-down menu 602. The Standard Comparison selection will be discussed in further detail below. It should be appreciated that the Definitions hyperlink or display area 616 may reflect the option selected and provide definitions of the type of actions that may be performed with that particular action or comparison, etc. In this example, the Definitions hyperlink or display area 616 may present information related to the Standard Comparison option and/or other associated actions or results.

FIG. 6B depicts an illustrative flow for providing a standard comparison using a compare channel tool 600B, according to an exemplary embodiment. Details of the flow 600B may include description of the compare channel module 200 and its various components of FIG. 2. Referring to flow 600B for providing a standard comparison, the input module 202 may receive an old channel file 603a and a new channel 603b. The old channel file 603a and new channel file 603b may include files, such as extensible mark-up language (XML) files or other similar files. In this example, the XML files may contain channel-specific settings, which may be saved by the compare channel module 200 upon input. These channel-specific settings may be compared by the processor module 206. Furthermore, it should be appreciated that the storage module 204 may store the files for any duration or predetermined time. In the flow 600B, the output of the output module 208 may be a file comprising content or comparison information, such as a text file or other similar output file (e.g., xml, csv, xls, html, etc.). The comparison information outputted may include directories, files, DLL files, etc. from old and new channels, registry entries, new items added in the new channel, missing items in the new channel, etc.

FIG. 6C depicts an illustrative output screen of a standard comparison using a compare channel tool 600C, according to an exemplary embodiment. In the screen 600C, a “CompareLog.txt” output file may have several headings under which the comparison information may be displayed. For example, under a “\@/ File Information” header, comparison information related to the old and new channel files, such as names of the files of the comparison, may be presented. Under a “\@/ Brief Information of Old Channel” header, information related to old file may be presented. Under a “\@/ Brief Information of New Channel” header, information related to new file may be presented. Comparison information related to new items in the new channel may be displayed under “\@/ New Items added in New Channel,” comparison information related to missing items in the new channel may be displayed under “\@/ Missing Items in New Channel,” and comparison information related to date of creation, start time, end time, and total time of the comparison may be displayed under the “\@/Time Stamp and Total Process time Information for this File.” Although depicted using these headers and comparison information, other various headers and related comparison information may also be provided.

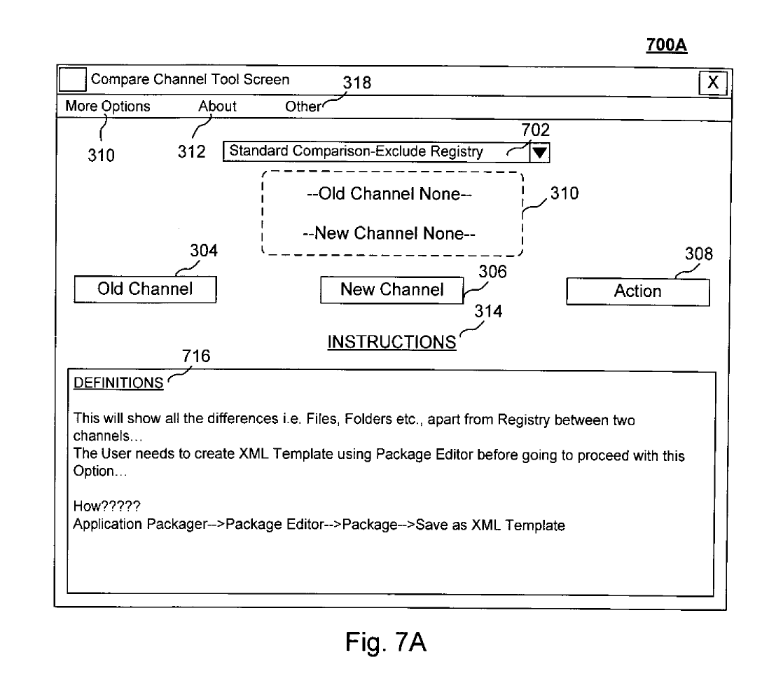

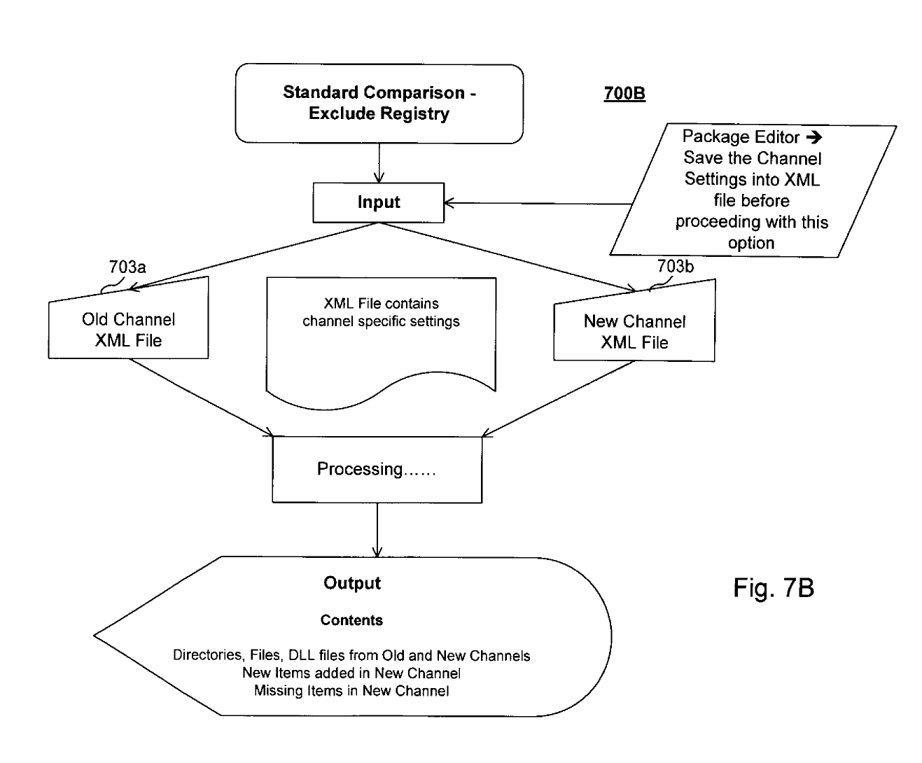

FIG. 7A depicts an illustrative screen for providing a standard comparison using a compare channel tool 700A, according to another exemplary embodiment. In this example, the compare channel tool screen 700A is similar to the compare channel tool screen 300 of FIG. 3. In this embodiment, a Standard Comparison (Exclude Registry) option 702 may be selected from the pull-down menu 702. The Standard Comparison (Exclude Registry) selection will be discussed in further detail below. It should be appreciated that the Definitions hyperlink or display area 716 may reflect the option selected and provide definitions of the type of actions that may be performed with that particular action or comparison, etc. In this example, the Definitions hyperlink or display area 716 may present information related to the Standard Comparison (Exclude Registry) option and/or other associated actions or results.

FIG. 7B depicts an illustrative flow for providing a standard comparison using a compare channel tool 700B, according to another exemplary embodiment. Details of the flow 700B may include description of the compare channel module 200 and its various components of FIG. 2. Referring to flow 700B for providing a standard comparison, the input module 202 may receive an old channel file 703a and a new channel 703b. The old channel file 703a and new channel file 703b may include files, such as XML files or other similar files. In this example, the XML files may contain channel-specific settings, which may be saved by the compare channel module 200 upon input. These channel-specific settings may be compared by the processor module 206. Furthermore, it should be appreciated that the storage module 204 may store the files for any duration or predetermined time. In the flow 700B, the output of the output module 208 may be a file comprising content or comparison information, such as a text file or other similar output file (e.g., xml, csv, xls, html, etc.). The comparison information outputted by the output 208 may include directories and/or files (e.g., DLL files) from old and new channels, new items added in the new channel, missing items in the new channel, etc. The difference between the standard comparison of this flow 700B, when compared to flow 600B, may be exclusion of registries in the processing and outputting. It should be appreciated that other various types of exclusions (or additions) may be provided.

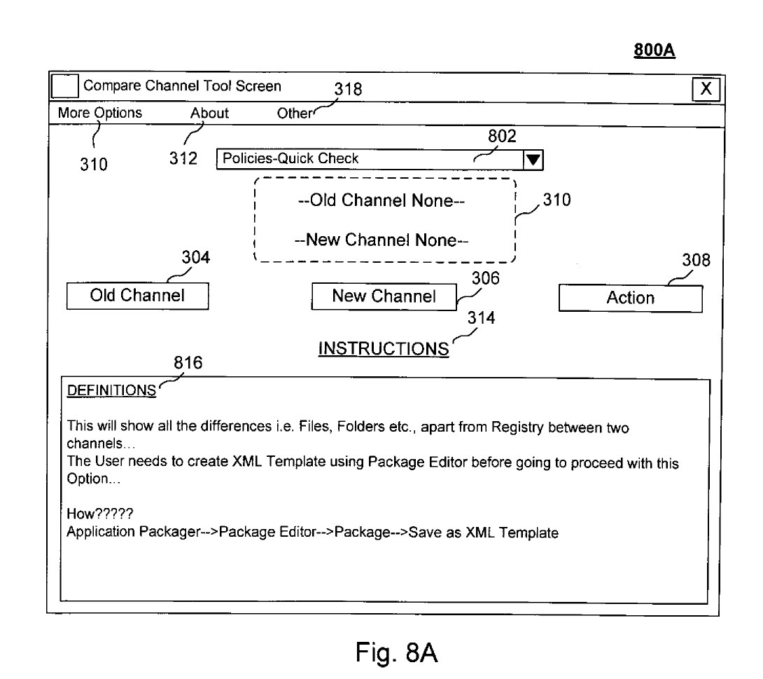

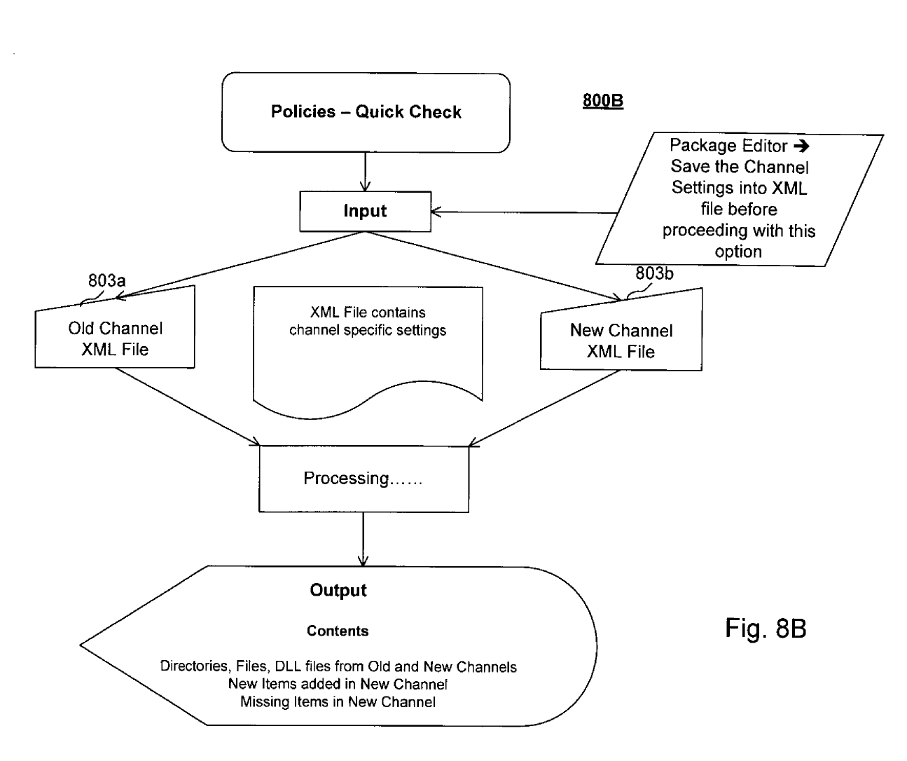

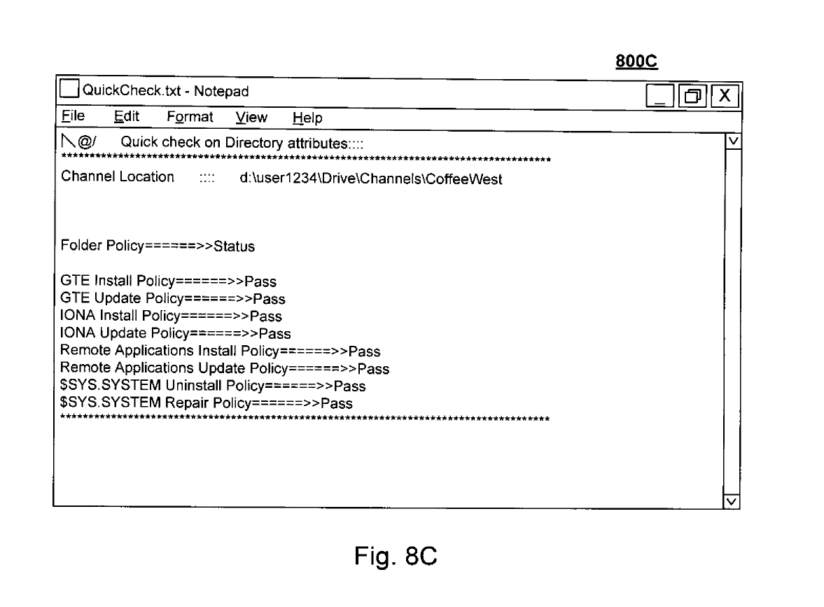

FIG. 8A depicts an illustrative screen for providing a policies comparison using a compare channel tool 800A, according to an exemplary embodiment. In this example, the compare channel tool screen 800A is similar to the compare channel tool screen 300 of FIG. 3. However, in this compare channel tool screen 800A, a Policies option 802 may be selected from the pull-down menu. In this embodiment, the Policies selected may by a Policies (Quick Check) selection, which will be discussed in further detail below. It should be appreciated that the Definitions hyperlink or display area 816 may reflect the option selected and provide definitions of the type of actions that may be performed with that particular action or comparison, etc. In this example, the Definitions hyperlink or display area 416 may present information related to the Policies (Quick Check) option and/or other associated actions or results.

FIG. 8B depicts an illustrative flow for providing a policies comparison using a compare channel tool 800B, according to an exemplary embodiment. Details of the flow 800B may include description of the compare channel module 200 and its various components of FIG. 2. Referring to flow 800B for providing a policies comparison, the input module 202 may receive an old channel file 803a and a new channel 803b. The old channel file 803a and new channel file 803b may include files, such as XML files or other similar files. In this example, the XML files may contain channel-specific settings, which may be saved by the compare channel module 200 upon input, and these channel-specific settings may be compared by the processor module 206. Furthermore, it should be appreciated that the storage module 204 may store the files for any duration or predetermined time. In the flow 800B, the output of the output module 208 may be a file comprising content or comparison information, such as a text file or other similar output file (e.g., xml, csv, xls, html, etc.). The comparison information outputted may include directories, files, DLL files, etc. from old and new channels, new items added in the new channel, missing items in the new channel, etc.

FIG. 8C depicts an illustrative output screen of a policies comparison using a compare channel tool 800C, according to an exemplary embodiment. In the screen 800C, a “QuickCheck.txt” output file may have several headings under which the comparison information may be displayed. For example, under a “\@/ Quick check on Directory attributes” header, comparison information related to various policies may be presented. For example, attributes of one or more policies may be identified as “status,” “pass,” or other attribute identifier. The channel location may also be provided. Although depicted using this header and data, other various headers and related data related to policies may also be provided.

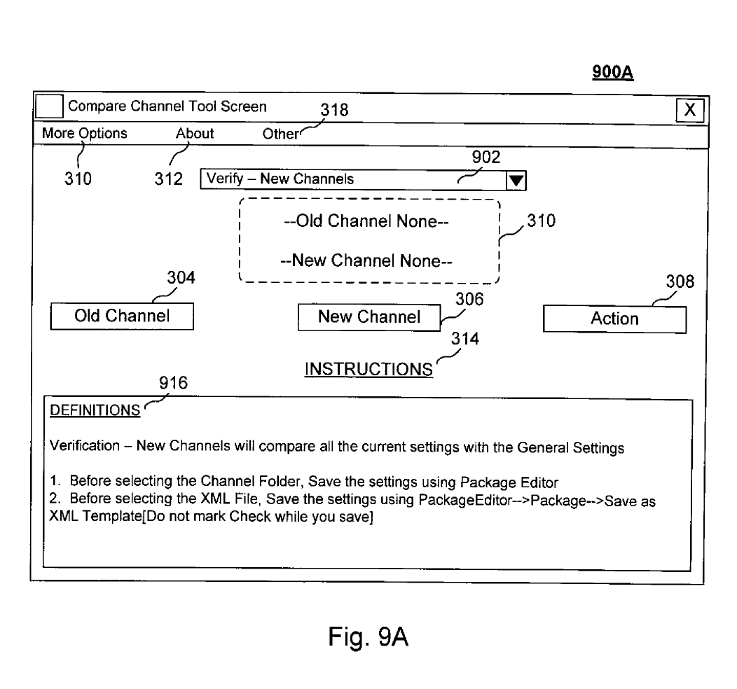

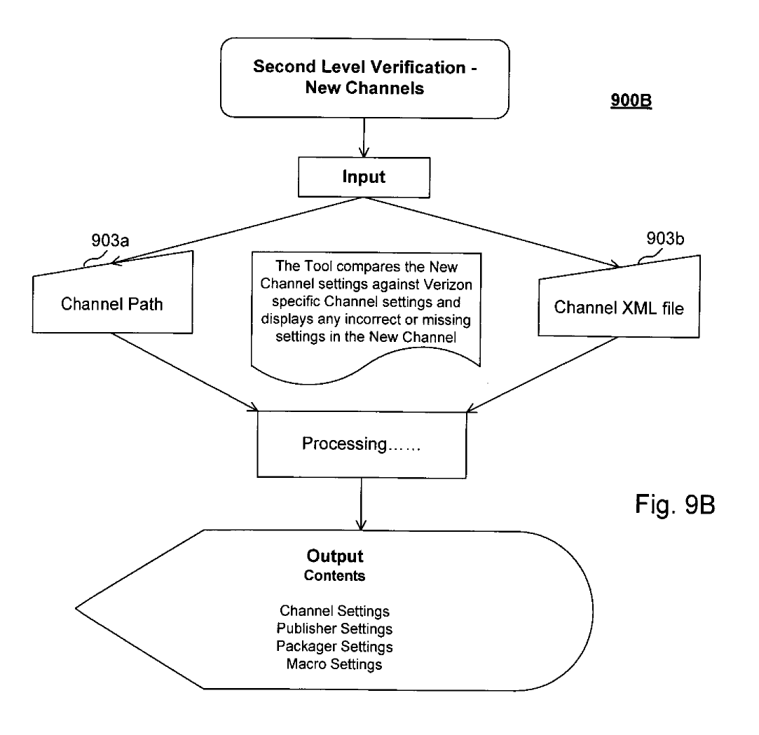

FIG. 9A depicts an illustrative screen for providing a verification comparison using a compare channel tool 900A, according to an exemplary embodiment. In this example, the compare channel tool screen 900A is similar to the compare channel tool screen 300 of FIG. 3. In this embodiment, a Verify option 902 may be selected from the pull-down menu 902. The Verify comparison option may be a Verify (New Channels) selection, which will be discussed in further detail below. It should be appreciated that the Definitions hyperlink or display area 916 may reflect the option selected and provide definitions of the type of actions that may be performed with that particular action or comparison, etc. In this example, the Definitions hyperlink or display area 916 may present information related to the Verify (New Channels) option and/or other associated actions or results.

FIG. 9B depicts an illustrative flow for providing a verification comparison using a compare channel tool 900B, according to an exemplary embodiment. Details of the flow 900B may include description of the compare channel module 200 and its various components of FIG. 2. A verification comparison may take new channels and compare current settings with that of general settings. Referring to flow 900B for providing a verify (new channels) comparison, the input module 202 may receive an old channel path 903a and a new channel file 903b. The new channel file 903b may include files, such as XML files or other similar files. In this example, the new channel settings may be compared against the channel settings using the processor module 206. Any incorrect or missing settings in the new channel file, for example, may then be highlighted or outputted at the output module 208. Furthermore, it should be appreciated that the storage module 204 may store the files for any duration or predetermined time. In the flow 900B, the output of the output module 208 may be a file comprising content or comparison information, such as a text file or other similar output file (e.g., xml, csv, xls, html, etc.). The comparison information outputted may include various settings, such as channel settings, publisher, settings, packager settings, macro settings, and other similar settings.

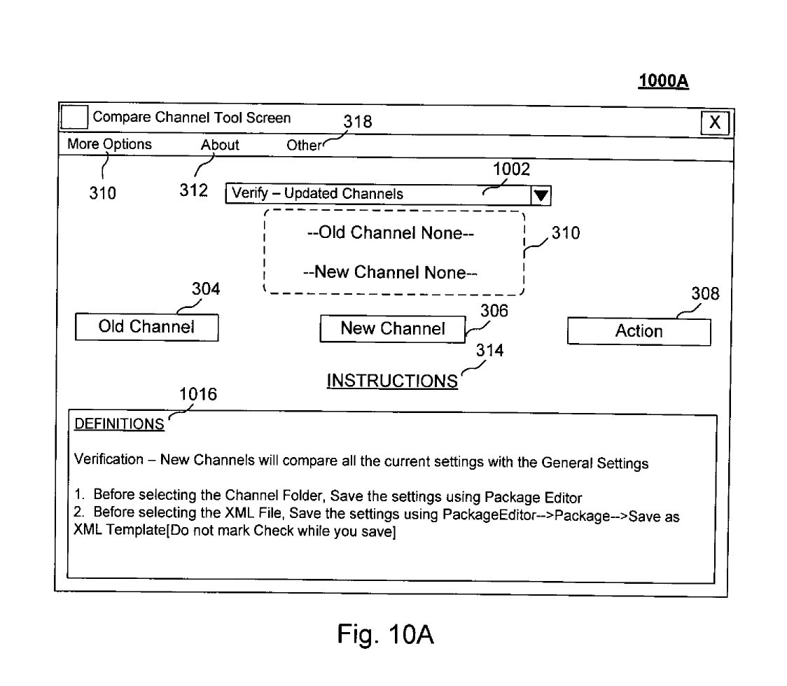

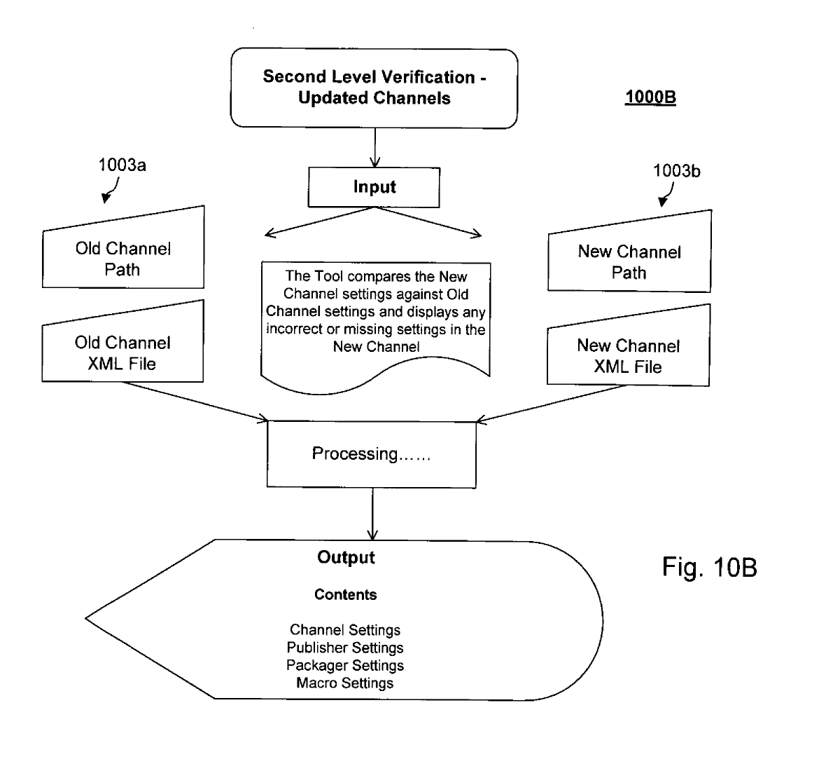

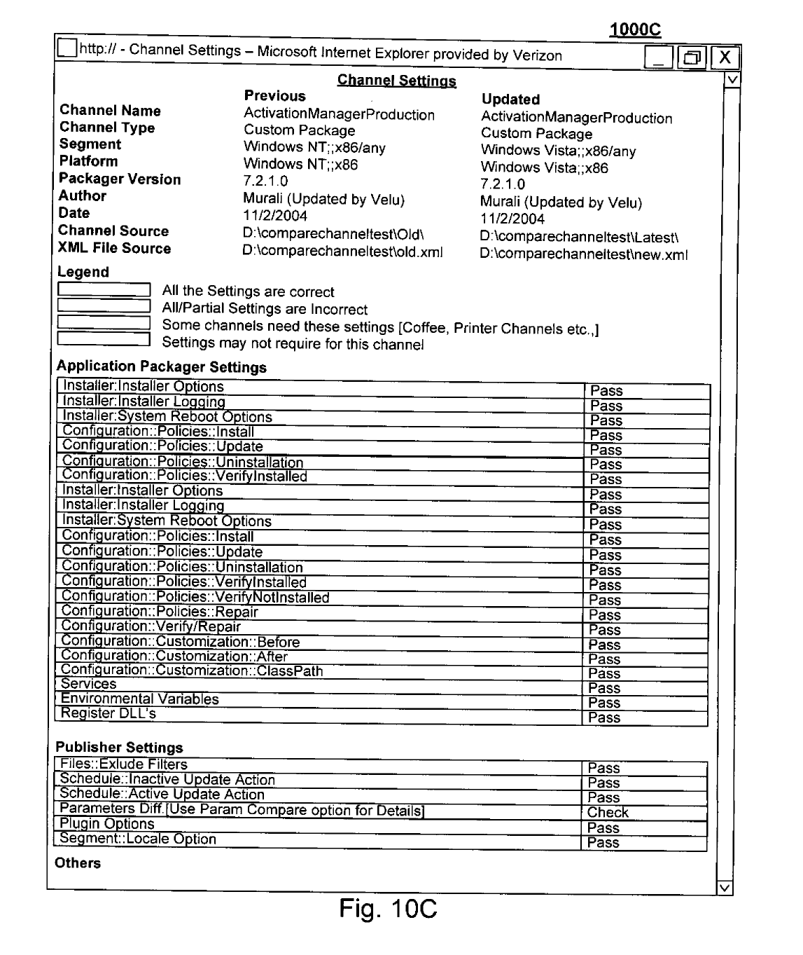

FIG. 10A depicts an illustrative screen for providing a verification comparison using a compare channel tool 1000A, according to another exemplary embodiment. In this example, the compare channel tool screen 1000A is similar to the compare channel tool screen 300 of FIG. 3. In this embodiment, a Verify option 1002 may be selected from the pull-down menu 1002. The Verify comparison option may be a Verify (Updated Channels) selection, which will be discussed in further detail below. It should be appreciated that the Definitions hyperlink or display area 1016 may reflect the option selected and provide definitions of the type of actions that may be performed with that particular action or comparison, etc. In this example, the Definitions hyperlink or display area 1016 may present information related to the Verify (Updated Channels) option and/or other associated actions or results.

FIG. 10B depicts an illustrative flow for providing a verification comparison using a compare channel tool 1000B, according to another exemplary embodiment. Details of the flow 1000B may include description of the compare channel module 200 and its various components of FIG. 2. A verification comparison may take new channels and compare current settings with that of general settings. Referring to flow 1000B for providing a verify (updated channels) comparison, the input module 202 may receive an old channel path and old channel file 1003a and a new channel path and new channel file 1003b. The old channel file 1003a and the new channel file 1003b may be XML files or other similar files. In this example, the new channel settings may be compared against the channel settings using the processor module 206. Any incorrect or missing settings in the new channel file, for example, may then be highlighted or outputted at the output module 208. Furthermore, it should be appreciated that the storage module 204 may store the files for any duration or predetermined time. In the flow 1000B, the output of the output module 208 may be a file comprising content or comparison information, such as a text file or other similar output file (e.g., xml, csv, xls, html, etc.). The comparison information outputted may include various settings, such as channel settings, publisher, settings, packager settings, macro settings, and other similar settings.

FIG. 10C depicts an illustrative output screen of a verification comparison using a compare channel tool 1000C, according to an exemplary embodiment. In the screen 1000C, a web-based output (e.g., html file) may be presented and may have several headings under which the comparison information may be displayed. For example, under a “Channel Settings” header, comparison information related to “previous” and “updated” items may be provides. These may include channel name, channel type, segment, platform, packager version, author, date, channel source, XML file source, and other various comparison items. It should be appreciated that the screen 1000C may also provide a legend, as well as other items for comparison, such as “Application Packager Settings,” “Publisher Settings,” and other various settings. In this example, under the “Publisher Settings” header, a “check” identifier may be presented to inform the user that a particular settings needs to be checked. In this case, “Parameters Diff. [Use Param Compare option for Details.]” is the setting and the user may select the hyperlink provided to find out more information about this updated setting. Although depicted using the particular configuration and items above, other various configurations and data related to settings and verifications may also be provided.

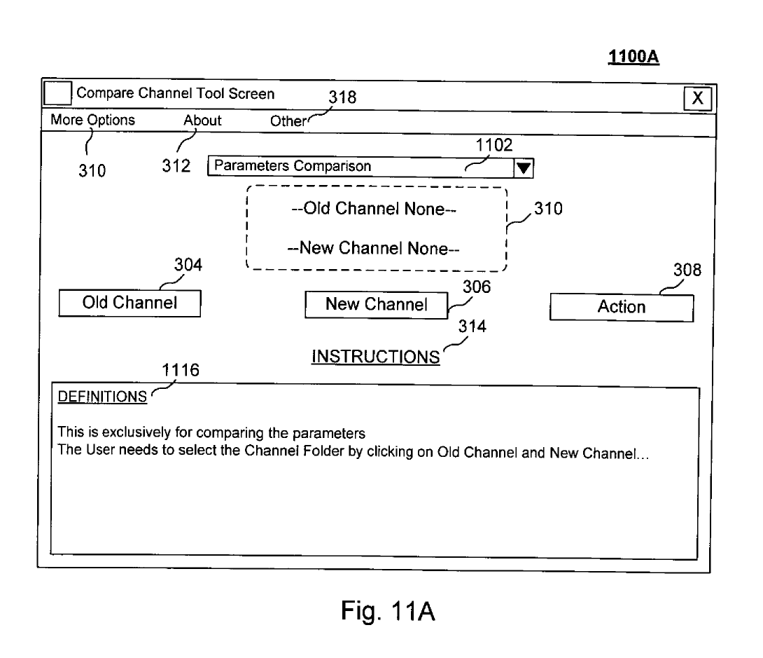

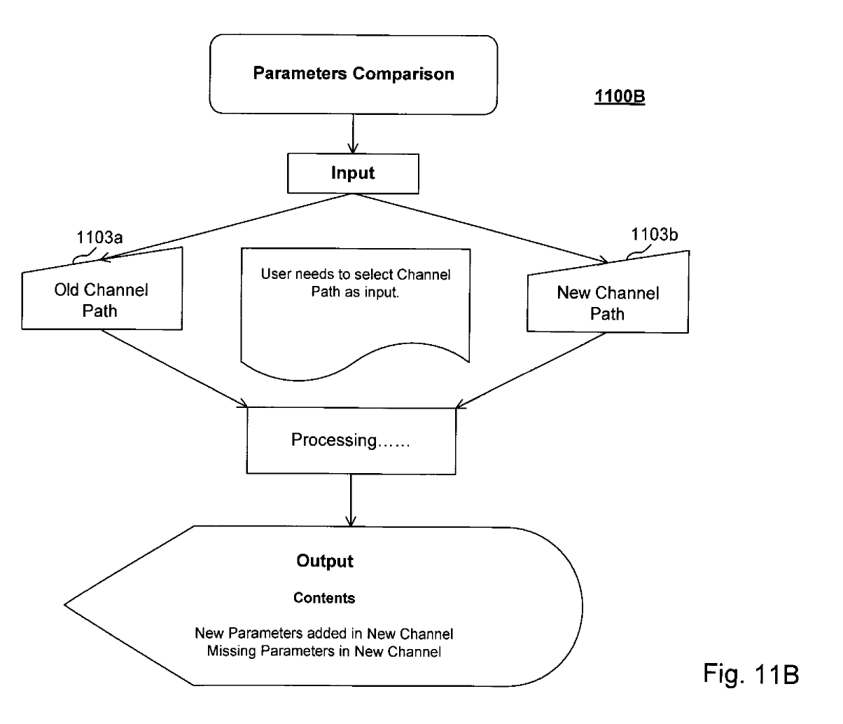

FIG. 11A depicts an illustrative screen for providing a parameters comparison using a compare channel tool 1100A, according to an exemplary embodiment. In this example, the compare channel tool screen 1100A is similar to the compare channel tool screen 300 of FIG. 3. In this embodiment, a Parameters Comparison option 1102 may be selected from the pull-down menu 1102. The Parameters Comparison may be used for comparing parameters and will be discussed in further detail below. It should be appreciated that the Definitions hyperlink or display area 1116 may reflect the option selected and provide definitions of the type of actions that may be performed with that particular action or comparison, etc. In this example, the Definitions hyperlink or display area 1116 may present information related to the Parameters Comparison option and/or other associated actions or results.

FIG. 11B depicts an illustrative flow for providing a parameters comparison using a compare channel tool 1100B, according to an exemplary embodiment. Details of the flow 1100B may include description of the compare channel module 200 and its various components of FIG. 2. A verification comparison may take new channels and compare current settings with that of general settings. Referring to flow 1100B for providing a verify (updated channels) comparison, the input module 202 may receive an old channel path 1103a and a new channel path 1103b. The old channel file 1103a and the new channel file 1103b may be XML files or other similar files. In this example, the new channel settings may be compared against the channel settings using the processor module 206. Any incorrect or missing settings in the new channel file, for example, may then be highlighted or outputted at the output module 208. Furthermore, it should be appreciated that the storage module 204 may store the files for any duration or predetermined time. In the flow 1100B, the output of the output module 208 may be a file comprising content or comparison information, such as a text file or other similar output file (e.g., xml, csv, xls, html, etc.). The comparison information outputted may include various settings, such as channel settings, publisher, settings, packager settings, macro settings, and other similar settings.

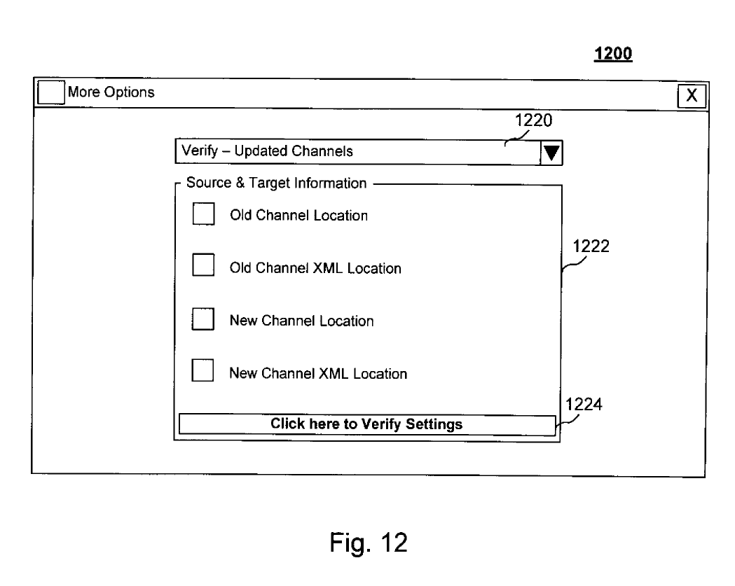

FIG. 12 depicts an illustrative screen for providing more comparison options using a compare channel tool 1200, according to an exemplary embodiment. The more options screen 1200 may include additional options not shown in the compare channel tool screen 300 of FIG. 3. In this example, another pull-down menu 1220 may be provided, providing various additional comparison tools. For instance, the “Verify (Updated Channels)” option may be selected and “Source & Target Information” selectable options may be presented, such as “Old Channel Location” (e.g., Old Channel Path Location), “Old Channel XML Location,” “New Channel Location” (e.g., New Channel Path Location), and “New Channel XML Location.” It should be appreciated that these selectable options may be based on the definitions of the type of actions that may be performed with that particular action or comparison, similar to those shown in the Definitions hyperlink or display area 1016 of FIG. 10A. The XML locations may also be similar to those defined above with respect to the Definitions hyperlink or display area 1016 of FIG. 10A. A button or link 1224 may be selected to “verify” these settings. It should be appreciated that a variety of other additional options to facilitate compare channel tool operation may also be provided in the more options screen 1200.

Other various embodiments and considerations may also be provided to optimize the compare channel tool described above. It should be appreciated that while embodiments are primarily directed to providing comparisons of old and new channels, comparisons of other items or content may also be provided. It should also be appreciated that while embodiments are primarily directed to user-friendly or interactive comparisons using a compare channel tool, other types of comparisons may also be provided. For example, comparisons at the compare channel tool may be configured for operation by one or more customers, analysts, operators, or administrators. In other embodiments, the compare channel tool may entirely automatic or may be a combination of manual and automatic comparison.

While depicted as various servers, components, elements, modules, or devices, it should be appreciated that embodiments may be constructed in software or hardware, as a separate or stand-alone device, or as part of an integrated system, device, or tool.

Additionally, it should also be appreciated that system support and updating the various components of the system or tool may be achieved. For example, a system administrator may have access to one or more of the components of the system, network, components, elements, or device. It should also be appreciated that the one or more servers, components, elements, or devices of the system may not be limited to physical components. These components may be computer-implemented software-based, virtual, etc. Moreover, the various servers, components, elements, or devices may be customized to perform one or more additional features and functionalities. Such features and functionalities may be provided via deployment, transmitting or installing software or hardware.

It should also be appreciated that each of the communications devices, servers, modules, or network elements may include one or more processors. It should be appreciated that one or more data storage systems (e.g., databases) may also be coupled to each of the devices or servers of the system. In one embodiment, the one or more data storage systems may store relevant information for each of the servers and system components. It should also be appreciated that software may be implemented in one or more computer processors, modules, network components, services, devices, or other similar systems.

It should be appreciated that the contents of any of these one or more data storage systems may be combined into fewer or greater numbers of data storage systems and may be stored on one or more data storage systems or servers. Furthermore, the data storage systems may be local, remote, or a combination thereof to client systems, servers, or other system components. In another embodiment, information stored in the databases may be useful in providing additional personalizations and customizations.

By providing a compare channel tool according to the above embodiments, a more efficient, accurate, and comprehensive way may be provided for eliminating or reducing problems associated with package distribution. Cost synergies and streamlined comparisons may also be achieved.

It should be appreciated that the system 100 of FIG. 1 and the system 200 of FIG. 2 may be implemented in a variety of ways. The architectures 100 and 200 may be implemented as a hardware component (e.g., as a module) within a network element or network box. It should also be appreciated that the architectures 100 and 200 may be implemented in computer executable software (e.g., on a computer-readable medium). Although depicted as a single architecture, module functionality of the architectures 100 and 200 may be located on a single device or distributed across a plurality of devices including one or more centralized servers and one or more pieces of customer premises equipment or end user devices.

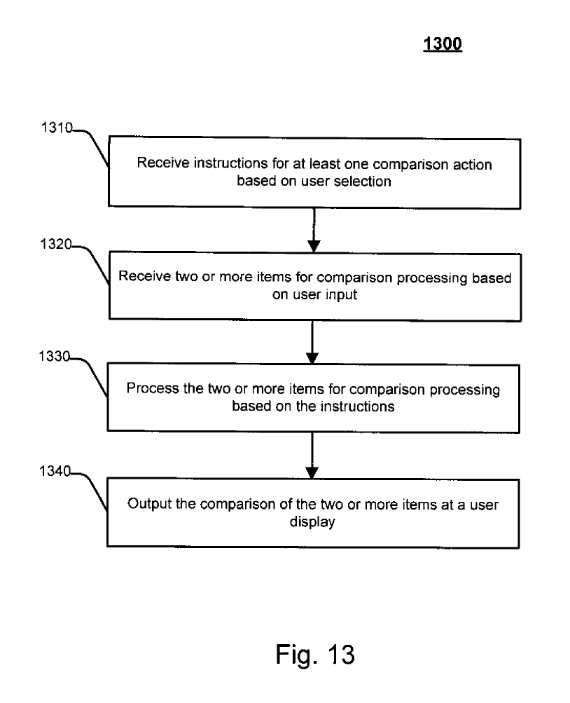

FIG. 13 depicts an illustrative flowchart of a method for providing a compare channel tool, according to another exemplary embodiment. The exemplary method 1300 is provided by way of example, as there are a variety of ways to carry out methods disclosed herein. The method 1300 shown in FIG. 13 may be executed or otherwise performed by one or a combination of various systems. The method 1300 is described below as carried out by at least system 100 in FIG. 1 and system 200 in FIG. 2, by way of example, and various elements of systems 100 and 200 are referenced in explaining the exemplary method of FIG. 13. Each block shown in FIG. 13 represents one or more processes, methods, or subroutines carried in the exemplary method 1300. A computer readable medium comprising code to perform the acts of the method 1300 may also be provided. Referring to FIG. 13, the exemplary method 400 may begin at block 1310.

At block 1310, the input module 202 of FIG. 2 may be configured to receive instructions for at least one comparison action based on a user selection. In some embodiments, the at least one instructions for the comparison action may be accessed by a user via a menu of comparison actions. The comparison action may comprise at least one a time stamp comparison, a standard comparison, a verification comparison, and a parameters comparison.

At block 1320, the input module 202 of FIG. 2 may be configured to receive two or more items for comparison processing based on user input. In some embodiments, the items may comprise settings that are saved before comparison processing. In other embodiments, the items may be saved as extensible mark-up language (XML) files or other similar files. It should be appreciated that the items may comprise files, channels, paths, packages, or combinations thereof.

At block 1330, the processor module 206 of FIG. 2 may be configured to process the two or more items for comparison processing based on the instructions. At block 1340, the output module 208 of FIG. 2 may be configured to output the comparison of the two or more items at a user display. In some embodiments, the output may be a printable report, which may be customizable to display information relevant or useful to a user.

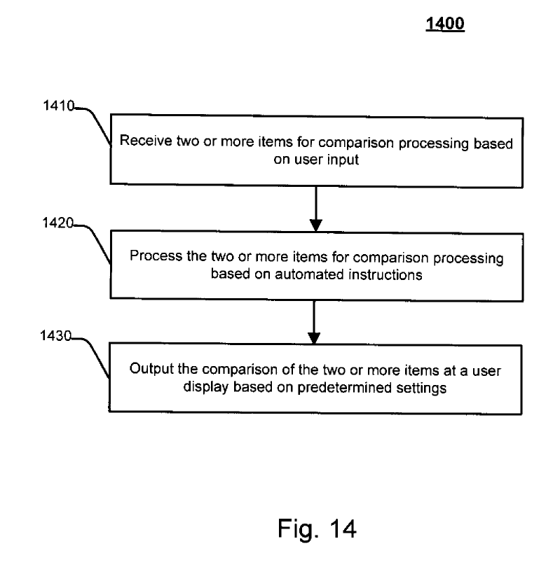

FIG. 14 depicts an illustrative flowchart of a method for using a compare channel tool, according to another exemplary embodiment. The exemplary method 1400 is provided by way of example, as there are a variety of ways to carry out methods disclosed herein. The method 1400 shown in FIG. 14 may be executed or otherwise performed by one or a combination of various systems. The method 1400 is described below as carried out by at least system 100 in FIG. 1 and system 200 in FIG. 2, by way of example, and various elements of systems 100 and 200 are referenced in explaining the exemplary method of FIG. 14. Each block shown in FIG. 14 represents one or more processes, methods, or subroutines carried in the exemplary method 1400. A computer readable medium comprising code to perform the acts of the method 1400 may also be provided. Referring to FIG. 14, the exemplary method 1400 may begin at block 1410.

At block 1410, the input module 202 of FIG. 2 may be configured to two or more items for comparison processing based on user input. In some embodiments, the items may comprise of at least one of files, channels, paths, and packages.

At block 1420, the processor module 206 of FIG. 2 may be configured to process the two or more items for comparison processing based on automated instructions. In this example, the automated instructions may be predetermined based on default instructions, identification of item type, predetermined user instructions, or a combination thereof.

At block 1430, the output module 208 of FIG. 2 may be configured to output the comparison of the two or more items at a user display based on predetermined settings. The comparison may comprise a time stamp comparison, a standard comparison, a verification comparison, a parameters comparison, or a combination thereof.

It should be appreciated that the set of instructions, e.g., the software, that configures the computer operating system to perform the operations described above may be contained on any of a wide variety of media or medium, as desired. Further, any data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by a computer.

In summary, embodiments may provide a system and method for comprehensively and effectively providing a compare channel tool. It should be appreciated that although embodiments are described primarily with systems management technologies, the systems and methods discussed above are provided as merely exemplary and may have other various applications and implementations.

In the preceding specification, various embodiments have been described with reference to the accompanying drawings. It will, however, be evident that various modifications and changes may be made thereto, and additional embodiments may be implemented, without departing from the broader scope of the disclosure as set forth in the claims that follow. The specification and drawings are accordingly to be regarded in an illustrative rather than restrictive sense.

We claim:

1. A system, comprising:
an input module configured to receive at least one instruction for a comparison action based on a user selection and to receive two or more items for comparison processing based on user input;
a processor module configured to process the two or more items for comparison processing based on the instructions; and
an output module configured to output the comparison results of the two or more items at a user display.

2. The system of claim 1, wherein the at least one instructions for the comparison action is accessed by a user via a menu of comparison actions.

3. The system of claim 1, wherein the comparison action comprises at least one a time stamp comparison, a standard comparison, a verification comparison, and a parameters comparison.

4. The system of claim 1, wherein the items comprise settings that are saved before comparison processing.

5. The system of claim 4, wherein the items are saved as extensible mark-up language (XML) files.

6. The system of claim 1, wherein the items comprises of at least one of files, channels, paths, and packages.

7. The system of claim 1, wherein the comparison results are useful for eliminating, mitigating, or preempting complications that arise in package distribution within a systems management technologies environment.

8. A method, comprising:
receiving, at an input module, at least one instruction for a comparison action based on a user selection and two or more items for comparison processing based on user input;
processing, at a processor module, the two or more items for comparison processing based on the instructions; and
outputting, at an output module, the comparison results of the two or more items at a user display.

9. The method of claim 8, wherein the at least one instructions for the comparison action is accessed by a user via a menu of comparison actions.

10. The method of claim 8, wherein the comparison action comprises at least one a time stamp comparison, a standard comparison, a verification comparison, and a parameters comparison.

11. The method of claim 8, wherein the items comprise settings that are saved before comparison processing.

12. The method of claim 11, wherein the items are saved as extensible mark-up language (XML) files.

13. The method of claim 8, wherein the items comprises of at least one of files, channels, paths, and packages.

14. The method of claim 8, wherein the comparison results are useful for eliminating, mitigating, or preempting complications that arise in package distribution within a systems management technologies environment.

15. A computer readable medium comprising code which when executed causes a computer to perform the method of claim 8.

16. A system, comprising:
an input module configured to two or more items for comparison processing based on user input;
a processor module configured to process the two or more items for comparison processing based on automated instructions; and
an output module configured to output the comparison of the two or more items at a user display based on predetermined settings.

17. The system of claim 16, wherein the items comprises of at least one of files, channels, paths, and packages.

18. The system of claim 16, wherein the automated instructions are predetermined based on at least one of default instructions, identification of item type, and predetermined user instructions.

19. The system of claim 16, wherein the comparison action comprises at least one a time stamp comparison, a standard comparison, a verification comparison, and a parameters comparison.

20. A method, comprising:
receiving, at an input module, two or more items for comparison processing based on user input;
processing, at a processor module, the two or more items for comparison processing based on automated instructions; and
outputting, at an output module, the comparison of the two or more items at a user display based on predetermined settings.

21. The method of claim 16, wherein the items comprises of at least one of files, channels, paths, and packages.

22. The method of claim 16, wherein the automated instructions are predetermined based on at least one of default instructions, identification of item type, and predetermined user instructions.

23. The method of claim 16, wherein the comparison action comprises at least one a time stamp comparison, a standard comparison, a verification comparison, and a parameters comparison.

24. A computer readable medium comprising code which when executed causes a computer to perform the method of claim 20.
